(19) United States
(12) Patent Application Publication
(10) Pub. No.: US 2023/0388966 A1
(43) Pub. Date: Nov. 30, 2023

(54) COORDINATION BETWEEN IDLE AND INACTIVE DISCONTINUOUS RECEPTION

(71) Applicant: QUALCOMM Incorporated, San Diego, CA (US)

(72) Inventor: Linhai HE, San Diego, CA (US)

(21) Appl. No.: 17/827,545

(22) Filed: May 27, 2022

(51) Int. Cl. H04W 68/02; H04W 76/28; H04W 76/27; H04W 52/02

(52) U.S. Cl. CPC H04W 68/02; H04W 76/28; H04W 76/27; H04W 52/0229

(57) ABSTRACT

Aspects of the present disclosure relate to wireless communications, and more particularly, to techniques for coordination between RRC Idle and RRC Inactive for eDRX configuration and procedure.

### BACKGROUND

### Field of the Disclosure

Aspects of the present disclosure relate to wireless communications, and more particularly, to techniques for coordinating paging monitoring during different user equipment (UE) power saving states.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes receiving, from a network entity, a first discontinuous reception (DRX) mode configuration for a first radio resource control (RRC) state, wherein the first DRX mode configuration specifies a periodic first paging time window (PTW), and a second DRX mode configuration for a second RRC state, wherein the second DRX mode configuration specifies a periodic second PTW; entering the first RRC state; and monitoring for different types of paging, when the UE is in the first RRC state, according to a schedule determined based on the first DRX mode configuration and the second DRX mode configuration.

Another aspect provides a method of wireless communications by a network entity. The method includes transmitting, to a UE, a first DRX mode configuration for a first RRC state, wherein the first DRX mode configuration specifies a periodic first PTW, and a second DRX mode configuration for a second RRC state, wherein the second DRX mode configuration specifies a periodic second PTW; and transmitting different types of paging according to a schedule determined based on the first DRX mode configuration and the second DRX mode configuration.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example call flow diagram for paging monitoring, in accordance with aspects of the present disclosure.

FIG. 6 depicts an example of coordinating paging monitoring between different UE states, in accordance with aspects of the present disclosure.

FIG. 7 depicts another example of coordinating paging monitoring between different UE states, in accordance with aspects of the present disclosure.

FIG. 8 depicts a method for wireless communications.

FIG. 9 depicts a method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for coordinating UE paging monitoring between different UE states. For example, the techniques proposed herein may help provide efficient paging as a UE in a radio resource control (RRC) inactive or RRC idle state.

Advanced wireless systems provide high data rates and improved latency, but at the potential cost of reduced battery life of a user equipment (UE). In an effort to save power and extend battery life of the UE, a mechanism referred to as Discontinuous Reception (DRX) was designed to allow the UE to power down radio frequency (RF) components when data transmissions are not anticipated.

The concept of DRX has been taken further with the development extended discontinuous reception (eDRX). eDRX provides flexibility to application developers on when and how long a UE stays in a low-power (sleep) mode before it wakes up to listen for any network indications for pending data. With DRX, the length of time that the UE sleeps before waking up is dictated by the network (typically 1.28 seconds or 2.56 seconds). With eDRX, the device, rather than the network, chooses the length of time it will sleep, a period referred to as the eDRX cycle. Since a device is not reachable when it is sleeping, the length of the eDRX cycle represents a tradeoff between power savings and ability to quickly reach the device via a paging mechanism.

Paging generally refers to the mechanism in which the network notifies the UE there is some type of information available for the UE. The UE monitors for paging and defined periods of time to decode paging messages. If eDRX is configured for a UE, with an eDRX cycle above a certain duration, a paging timing window (PTW) can be configured, where the interval between adjacent PTWs is the eDRX cycle.

There are a number of rules for UE paging monitoring that depend on an eDRX configuration. For example, if the UE is not configured with eDRX, the UE may need to monitor for paging messages with system information (SI) updates that are advertised every default paging cycle (configured by network). Otherwise, if the UE is configured with eDRX, the UE may not need to monitor for SI updates every default paging cycle, rather the UE can follow an SI modification period configured by network.

Rules for UE paging monitoring may also depend on whether the UE is in a radio resource control (RRC) idle or RRC inactive state. For example, when the UE is in an RRC inactive state, in addition to monitoring for radio access network (RAN) paging according to the default paging cycle, the UE may also need to monitor for core network (CN) paging, sent according to an RRC Idle eDRX cycle or a UE-specific DRX cycle if eDRX is not configured. Such rules may be designed to prevent potential RRC state mismatch, in which case the CN thinks the UE is in RRC Idle when the UE is actually in RRC Inactive.

Current UE paging monitoring rules also limit flexibility with respect to eDRX cycle lengths for RRC Inactive and RRC Idle states. For example, such rules may prevent the configuration of an eDRX cycle for RRC Inactive, if an eDRX cycle is not configured for RRC Idle. Such rules may also prevent an eDRX cycle for RRC Inactive that is longer than an eDRX cycle for RRC Idle. This limited flexibility may result in less than optimal power savings (e.g., if an eDRX cycle for RRC Inactive or Idle is set too short) or increased latency when trying reach a UE (e.g., if an eDRX cycle for RRC Inactive or Idle is set too long).

Aspects of the present disclosure may help provide flexibility in setting eDRX cycle lengths for RRC Inactive and Idle states. For example, aspects of the present disclosure provide techniques for coordinating between eDRX configurations of RRC Idle and RRC Inactive and for UE paging monitoring when in RRC Inactive when paging time windows (PTWs) are configured. The techniques presented herein may provide flexibility by allowing the network to configure PTWs of different lengths for RRC Idle and RRC Inactive. Based on this configuration, a schedule for transmission and monitoring of different types of paging may be determined based on certain conditions.

By utilizing techniques presented herein, eDRX cycles may be flexibly configured so that a UE is able to efficiently monitor for different types of paging without having to establish a full network connection. The ability to set the lengths of PTWs and eDRX cycles may provide application developers with increased flexibility to balance UE reachability with battery consumption.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

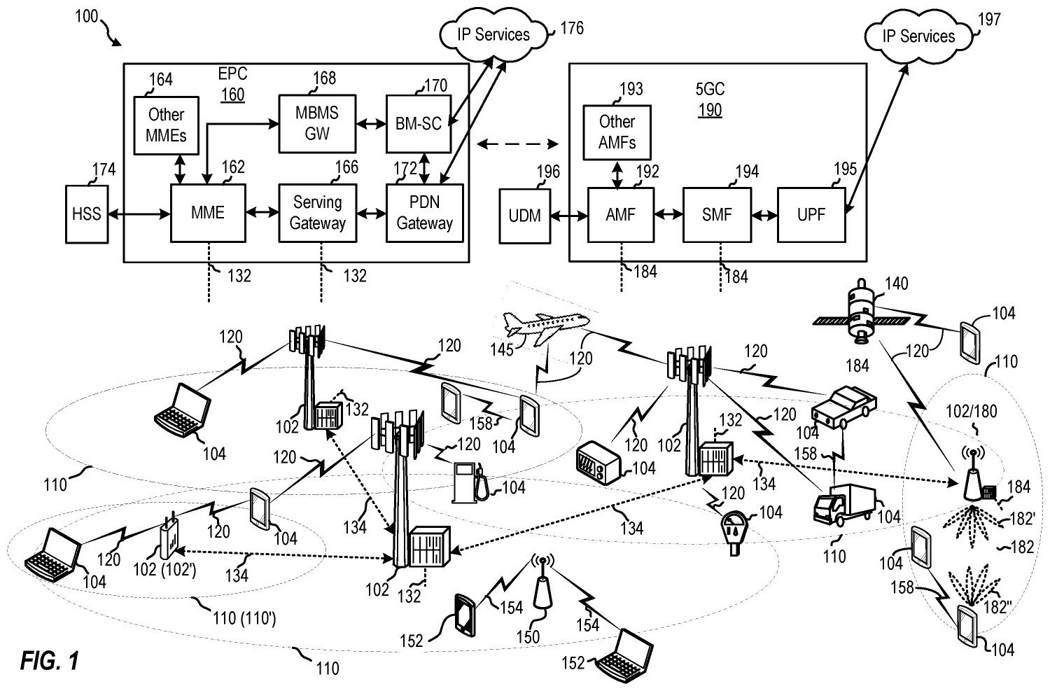

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

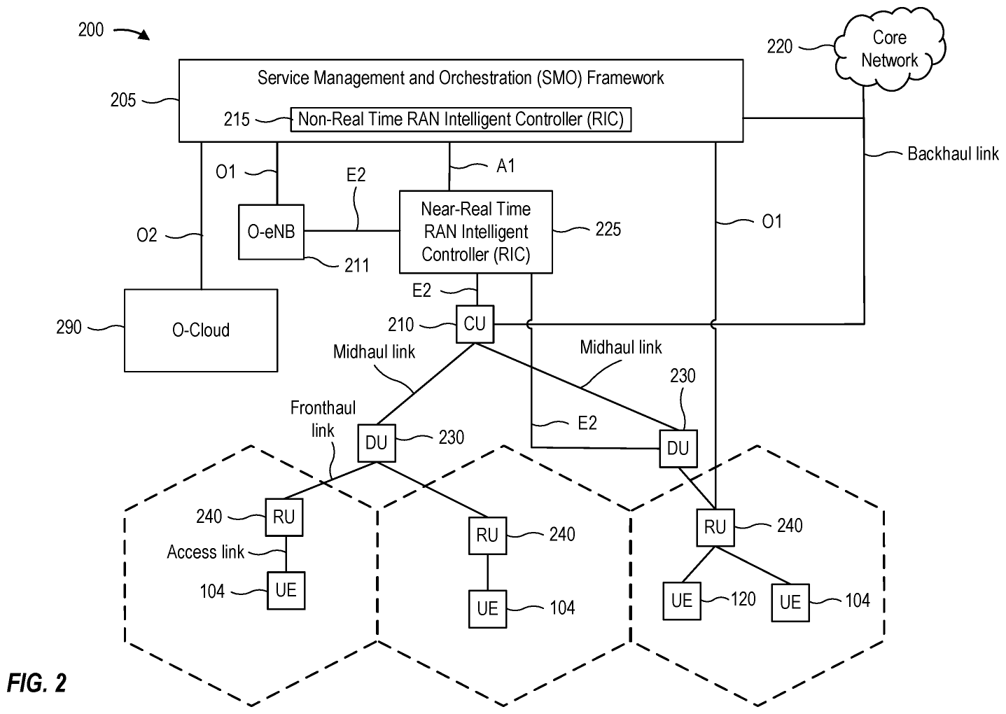

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., an mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) MC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT MC 225, the Non-RT RIC 215 may receive parameters or external enrichment information from external servers. Such information may be utilized by the Near-RT MC 225 and may be received at the SMO Framework 205 or the Non-RT MC 215 from non-network data sources or from network functions. In some examples, the Non-RT MC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

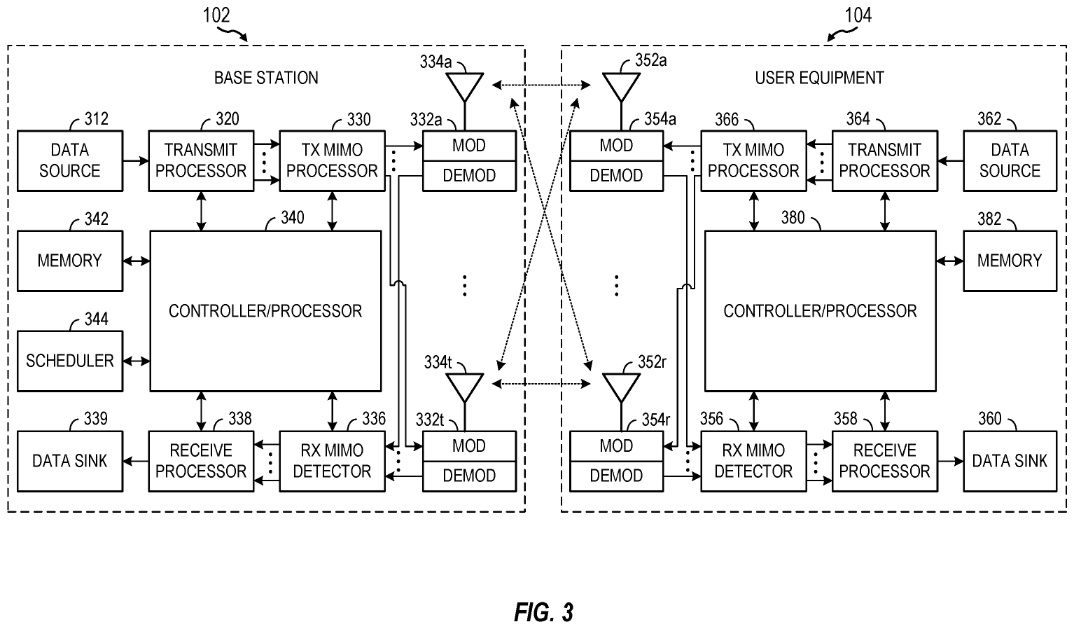

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

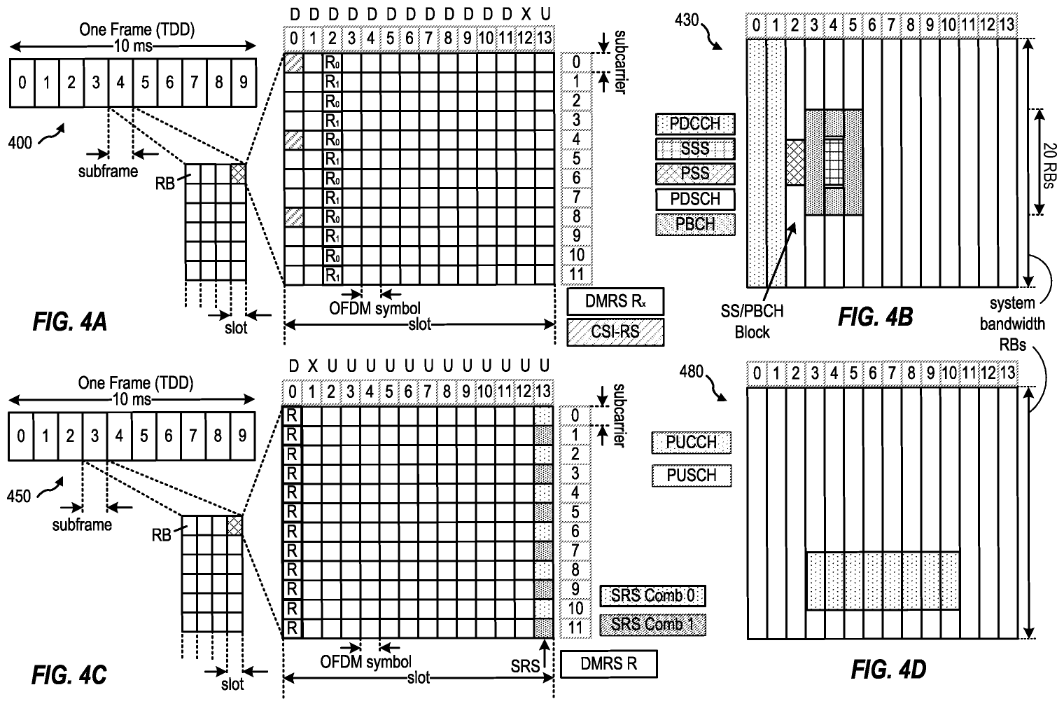

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of eDRX Configuration and Paging Monitoring

As noted above, Discontinuous Reception (DRX) was designed as a mechanism to allow the UE to power down radio frequency (RF) components when data transmissions are not anticipated. Extended DRX (eDRX), introduced in LTE for RRC Idle, enables greater power savings by allowing for longer cycles (than DRX) so a UE can stays in a low-power mode longer, before having to wake up to listen for any network indications for pending data.

eDRX is typically configured by the core network (CN) and may involve periodic paging time windows (PTWs). The time and length of a PTW is UE-specific and is determined by a hyper paging frame (HPF). If eDRX cycle is greater than a threshold value (e.g., >10.24 s), an HPF and PTW may be configured

The interval between two adjacent PTWs corresponds to the eDRX cycle. Within a PTW, the UE monitors a paging channel according to a periodicity T, where T is a minimum of the default paging cycle of the serving cell and a UE specific DRX cycle, if configured. Outside of PTWs, the UE does not monitor for paging and may stay in a low power state.

When a UE is in an RRC Inactive state, the UE is still considered as being connected from the CN perspective. In the RRC Inactive state, the UE monitors the paging channel according to a RAN paging cycle configured by the gNB. In LTE, the RRC Inactive state has a maximum eDRX cycle of 5.12 s. Because this is less than the (10.24 s) threshold, RRC Inactive in LTE does not have a PTW in any eDRX configuration.

As noted above, there are a number of rules for UE paging monitoring that depend on an eDRX configuration and whether the UE is in a radio resource control (RRC) idle or RRC inactive state. For example, when the UE is in an RRC inactive state, in addition to monitoring for RAN paging according to the default paging cycle, the UE may also need to monitor for CN paging, sent according to an RRC Idle eDRX cycle or a UE-specific DRX cycle if eDRX is not configured. Such rules may be designed to prevent potential RRC state mismatch, in which case the CN thinks the UE is in RRC Idle when the UE is actually in RRC Inactive.

Current rules for UE paging monitoring may prevent the configuration of an eDRX cycle for RRC Inactive, if an eDRX cycle is not configured for RRC Idle. Such rules may also prevent an eDRX cycle for RRC Inactive that is longer than an eDRX cycle for RRC Idle. This limited flexibility may result in eDRX cycle selection that is less than optimal for power savings, if set too short, or increased latency when trying reach the UE, if set too long.

### Aspects Related to Coordination Between RRC Idle and RRC Inactive States for eDRX Configuration

Aspects of the present disclosure may help provide flexibility in setting eDRX cycle lengths for RRC Inactive and Idle states. The techniques proposed herein may help coordinate between eDRX configurations of RRC Idle and RRC Inactive and may help define UE behavior for paging monitoring when in RRC Inactive when paging time windows (PTWs). In some cases, the techniques described herein may be considered as providing supplemental rules that may be applied as an alternative, or in conjunction with, the UE paging monitoring rules described above.

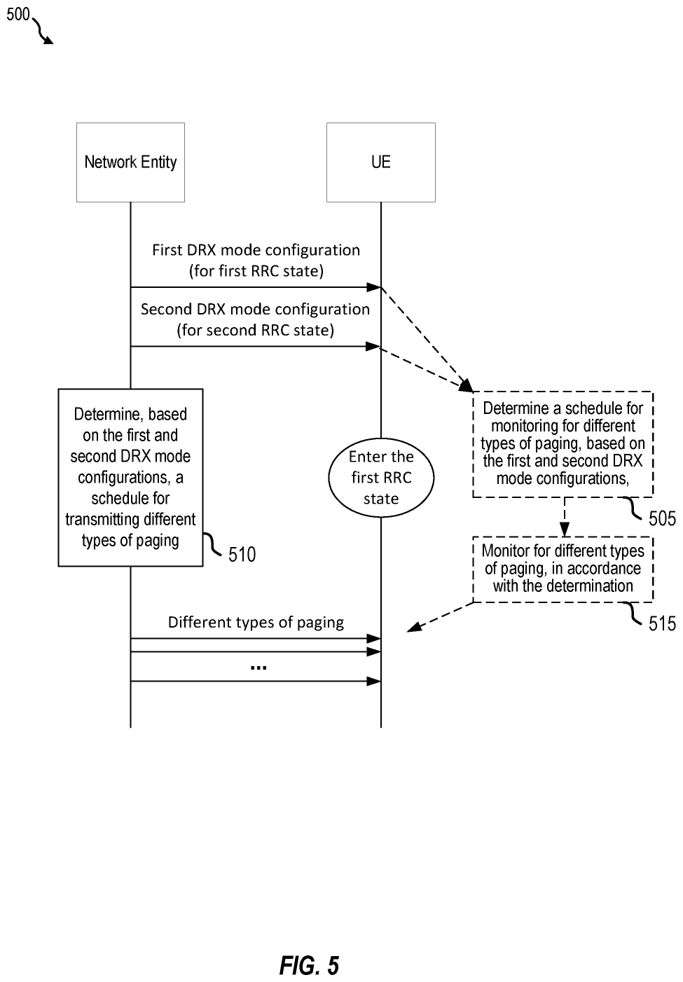

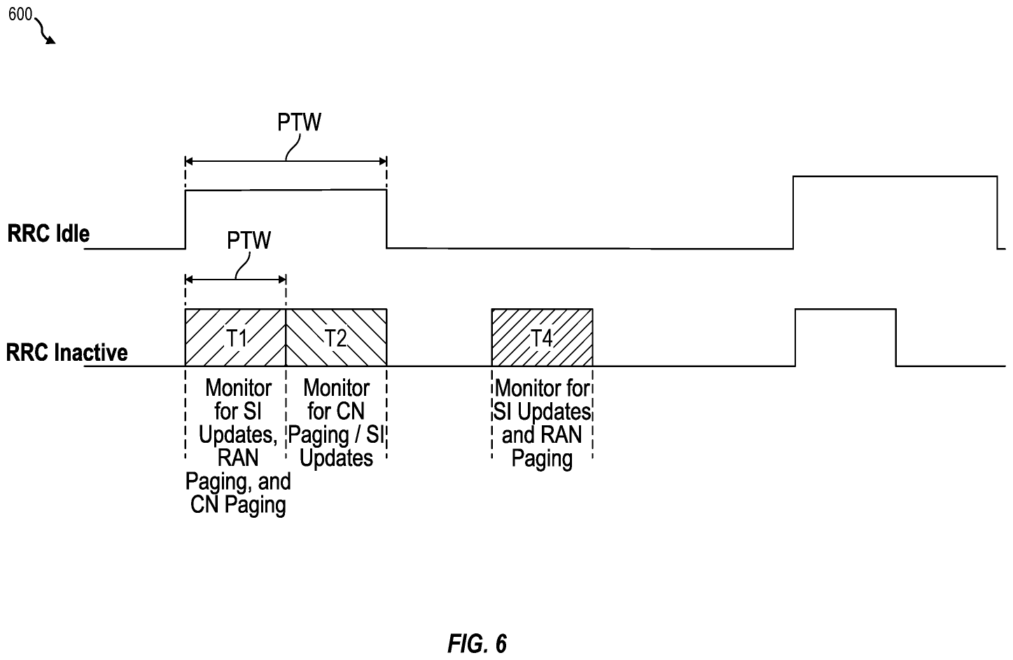

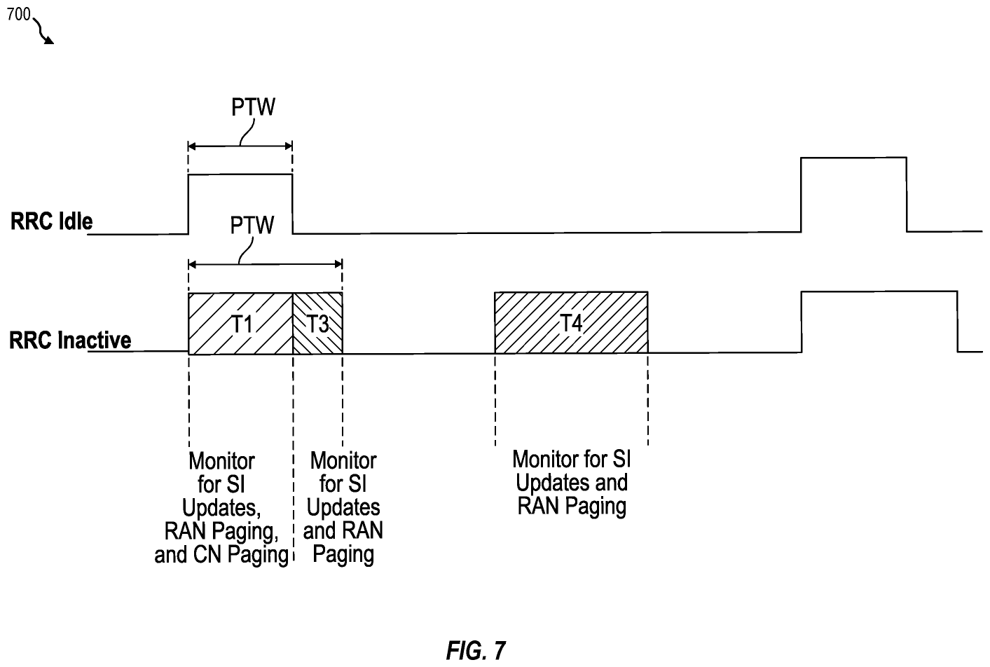

The techniques for UE paging monitoring presented herein may be understood with reference to the example call flow diagram 500 of FIG. 5 and the example timelines depicted in FIGS. 6 and 7.

As illustrated in FIG. 5, a network entity (e.g., a gNB or node of a disaggregated base station) may configure the UE with a first DRX mode configuration, for a first RRC state, that specifies a periodic first PTW. The network entity may also configure the UE with a second DRX mode configuration, for a second RRC state, that specifies a periodic second PTW. For example, the first RRC state may be an RRC inactive state and the second RRC state may be an RRC idle state.

In some cases, the first DRX mode configuration may also specify a first DRX cycle length and the second DRX mode configuration may also specify a second DRX cycle length. As noted above, DRX cycle lengths may correspond to the interval between periodic PTWs.

As illustrated, at 505, the UE may determine a schedule for monitoring for different types of paging, based on the first and second DRX mode configurations. Similarly, at 510, the network entity determines a schedule for transmitting the different types of paging, based on the first and second DRX mode configurations. Thus, the network entity and UE can be aligned regarding when the UE can expect to receive paging messages. At 515, the UE monitors for the different types of paging, in accordance with the determined schedule.

Aspects of the present disclosure may allow the eDRX cycle in RRC Inactive to be extended beyond 10.24 s and for PTWs to be configured for RRC Inactive as well. eDRX configurations of RRC Idle and RRC Inactive may be coordinated with different eDRX cycles for RRC Inactive and RRC Idle. For example, because the network typically expects data for the UE in near future when it releases a UE into an RRC Inactive state, shorter eDRX cycles may be configured for RRC Inactive (relative to RRC Idle).

As shown in the example timelines of FIG. 6 and FIG. 7, the network may also configure PTWs of different lengths for RRC Idle and RRC Inactive. The PTW length selection is typically more related to UE mobility and eDRX cycle (than whether it is in RRC Idle or RRC Inactive). In order to enhance power savings, PTW in RRC Idle and PTW in RRC Inactive may be configured to start at the same time (otherwise the UE would wake up based on the earliest occurring start time). In some cases, different network entities may coordinate regarding eDRX configurations. For example, the CN may provide a UE eDRX configuration for RRC Idle to a RAN entity (e.g., gNB), to help the RAN better configure the UE eDRX configuration for RRC Inactive.

FIG. 6 and FIG. 7 illustrate two basic scenarios in which a UE may monitor for paging, in accordance with aspects of the present disclosure. The timeline 600 of FIG. 6 illustrates a first scenario, when the PTW for RRC idle is longer than the PTW for RRC Inactive, while the timeline 700 of FIG. 7 illustrates a second scenario when the PTW for RRC inactive is longer than the PTW for RRC Idle. The timelines indicate different periods, T1-T4, which may be considered different parts of a UE paging monitoring schedule, in which the UE monitor for different types of paging.

For example, the first period T1 generally refers to the period where the PTWs of RRC Inactive and RRC Idle overlap. In the period, the UE may be configured to monitor for (default) paging for system information (SI) updates, RAN paging indicating downlink data for the UE, or CN paging. The time period for T1 may be defined as the minimum of the default paging cycle, RAN paging cycle, and UE-specific paging cycle (if configured).

The second period T2 generally refers to the period where the UE has terminated its PTW for RRC Inactive, but may still receive CN paging since PTW for RRC Idle eDRX may still be on, as in the example shown in FIG. 6.

In this cases, there are various options for possible UE behaviors. For example, according to a first option, although the UE has ended its PTW for RRC Inactive, the UE may still need to monitor for CN paging. In this case, the time period for T2 may correspond to the UE-specific paging cycle, if configured, or may correspond to the default paging cycle, if a UE-specific paging cycle is not configured.

According to a second option, since the UE is in an RRC Inactive state and the RRC Inactive PTW has ended, the UE may stop monitoring the paging channel and go to sleep. Even if a mismatch occurs in this period (where the CN thinks the UE is in RRC Idle) and the CN has a page for the UE, the CN may defer delivery of the page until the next PTW (thus, the paging may only be delayed rather than missed).

As illustrated in FIG. 7, the third period T3 generally refers to time after the UE has terminated its PTW for RRC Idle, but its PTW for RRC Inactive is still on. During this period, the UE may still monitor for RAN paging. In addition, because the UE is still within a PTW, it may still monitor for SI updates, per the default paging cycle. The time period for T3 may, thus, be defined as the minimum of the default paging cycle and the RAN paging cycle.

As illustrated in both FIG. 6 and FIG. 7, the fourth period T4 generally refers to the period resulting from the eDRX cycle for UE RRC Inactive being shorter than the eDRX cycle for RRC Idle. In other words, T4 corresponds to RRC Inactive PTWs that occur between RRC Idle PTWs.

From the perspective of UE paging monitoring, in T4 the UE may monitor for RAN paging and for SI updates, per the default paging cycle monitor. In other words, the UE may monitor perform paging monitoring for T4 in the same manner as described above for T3. Similarly, as with T3, the time period for T4 may be defined as the minimum of the default paging cycle, RAN paging cycle.

### Example Operations of a User Equipment

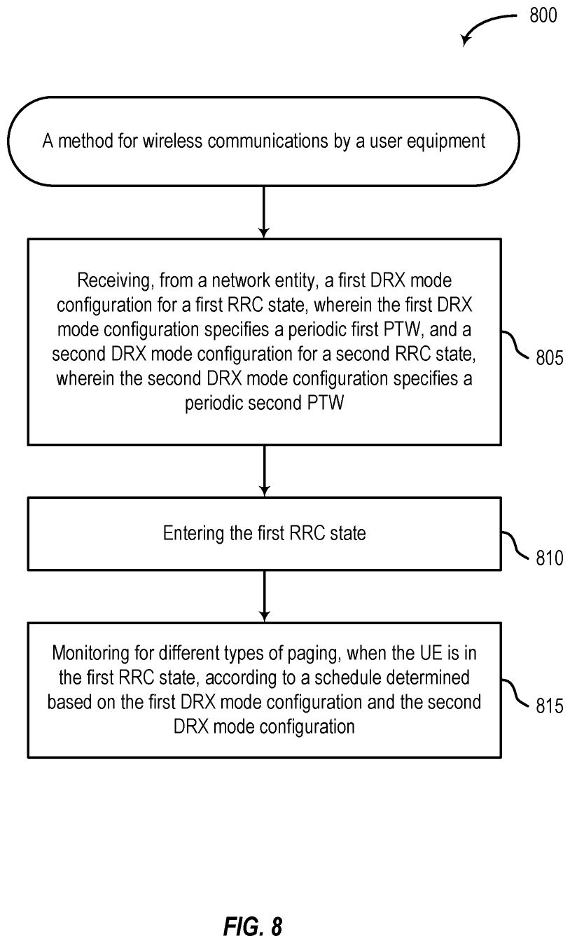

FIG. 8 shows a method 800 for wireless communications by a UE, such as UE 104 of FIGS. 1 and 3.

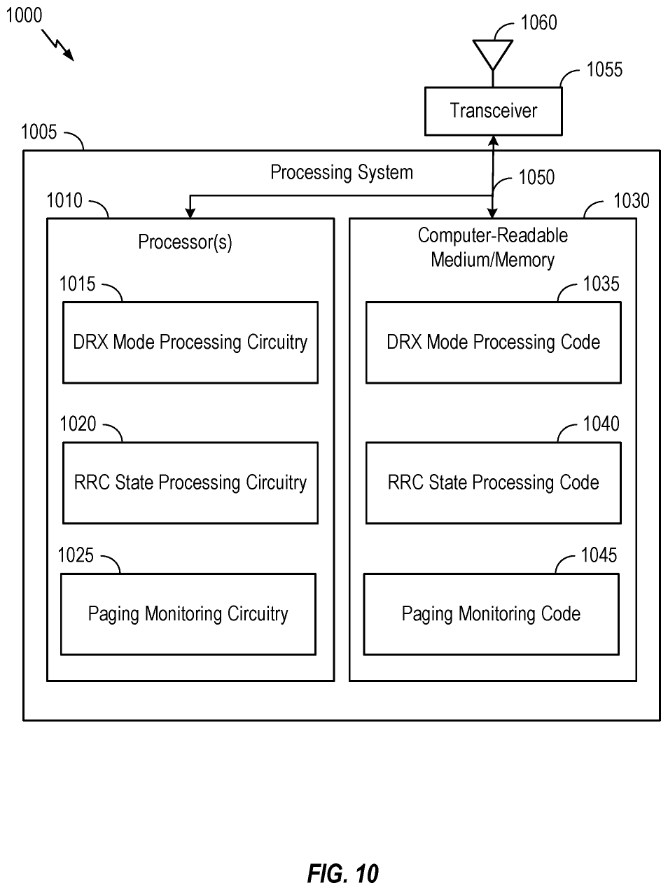

Method 800 begins at 805 with receiving, from a network entity, a first DRX mode configuration for a first RRC state, wherein the first DRX mode configuration specifies a periodic first PTW, and a second DRX mode configuration for a second RRC state, wherein the second DRX mode configuration specifies a periodic second PTW. In some cases, the operations of this step refer to, or may be performed by, DRX mode processing circuitry as described with reference to FIG. 10.

Method 800 then proceeds to step 810 with entering the first RRC state. In some cases, the operations of this step refer to, or may be performed by, RRC state processing circuitry as described with reference to FIG. 10.

Method 800 then proceeds to step 815 with monitoring for different types of paging, when the UE is in the first RRC state, according to a schedule determined based on the first DRX mode configuration and the second DRX mode configuration. In some cases, the operations of this step refer to, or may be performed by, paging monitoring circuitry as described with reference to FIG. 10.

In some aspects, the first RRC state is an RRC inactive state; and the second RRC state is an RRC idle state. In some aspects, the first DRX mode configuration also specifies a first DRX cycle length; an interval between a beginning of adjacent first PTWs corresponds to the first DRX cycle length; the second DRX mode configuration also specifies a second DRX cycle length; an interval between a beginning of adjacent second PTWs corresponds to the second DRX cycle length; and start times of at least some of the first PTWs align with start times of at least some of the second PTWs.

In some aspects, monitoring for different types of paging according to a schedule comprises: monitoring for one or more first types of paging during a first duration in which the first PTW and the second PTW overlap. In some aspects, the one or more first types of paging comprise: paging indicating SI updates, paging from a first network entity indicating downlink data for the UE, or paging from a second network entity indicating downlink data for the UE.

In some aspects, the first network entity comprises a RAN entity and the second network entity comprises a CN network entity. In some aspects, the first duration occurs with a periodicity determined based on a minimum of: a default paging cycle, a cycle for paging from the first network entity, and a cycle for paging from the second network entity.

In some aspects, the method 800 further includes determining that a duration of the second PTW is greater than a duration of the first PTW. In some aspects, the method 800 further includes stopping monitoring for paging after an end of the first PTW after making the determination.

In some aspects, monitoring for different types of paging according to a schedule further comprises: determining that a duration of the second PTW is greater than a duration of the first PTW; and monitoring for one or more second types of paging during a second duration after making the determination, wherein the second duration corresponds to a portion of the second PTW that is non-overlapping with the first PTW. In some aspects, the one or more second types of paging comprise: paging from the second network entity indicating downlink data for the UE. In some aspects, the second duration occurs with a periodicity determined based on a UE-specific paging cycle, if configured for the UE; or a default paging cycle, if a UE-specific paging cycle is not configured for the UE.

In some aspects, monitoring for different types of paging according to a schedule further comprises: determining that a duration of the first PTW is greater than a duration of the second PTW; and monitoring for one or more third types of paging during a third duration after making the determination, if, wherein the third duration corresponds to a portion of the first PTW that is non-overlapping with the second PTW.

In some aspects, the one or more third types of paging comprise: paging indicating SI updates and paging from the first network entity indicating downlink data for the UE. In some aspects, the third duration occurs with a periodicity determined based on a default paging cycle or a cycle for paging from the first network entity.

In some aspects, the first DRX mode configuration also specifies a first DRX cycle length that is shorter than a second DRX cycle length specified by the second DRX mode configuration; and monitoring for different types of paging according to a schedule further comprises monitoring during first PTWs that are non-overlapping with second PTWs, for paging indicating SI updates and paging from the first network entity indicating downlink data for the UE.

In some aspects, the UE monitors for paging indicating SI updates and for paging from the first network entity indicating downlink data for the UE during the first PTWs that are non-overlapping with second PTWs; and the first PTWs that are non-overlapping with second PTWs, during which the UE monitors for paging indicating SI updates and for paging from the first network entity indicating downlink data for the UE, occur with a periodicity determined based on a default paging cycle or a cycle for paging from the first network entity.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Operations of a Network Entity

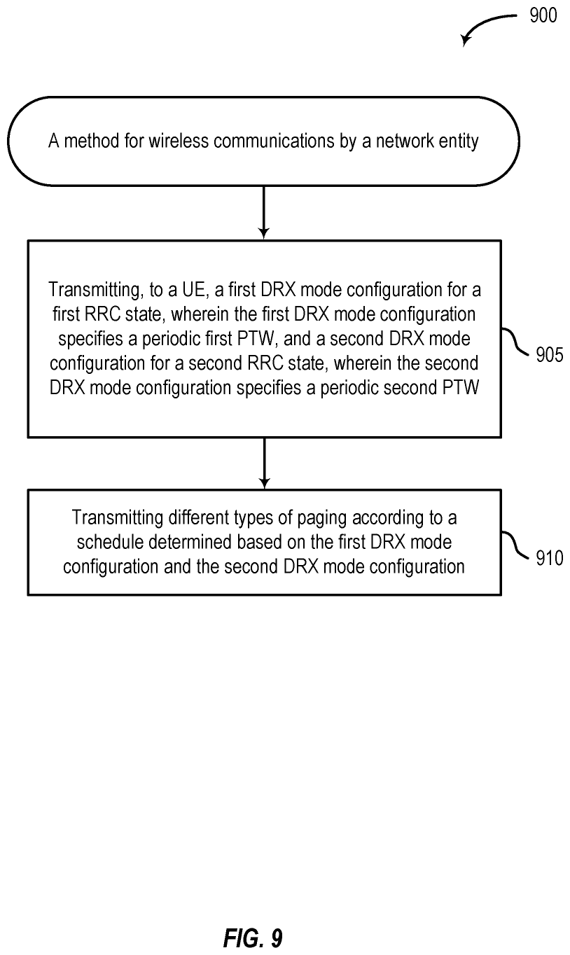

FIG. 9 shows a method 900 for wireless communications by a network entity, such as BS 102 of FIGS. 1 and 3, or a disaggregated base station as discussed with respect to FIG. 2.

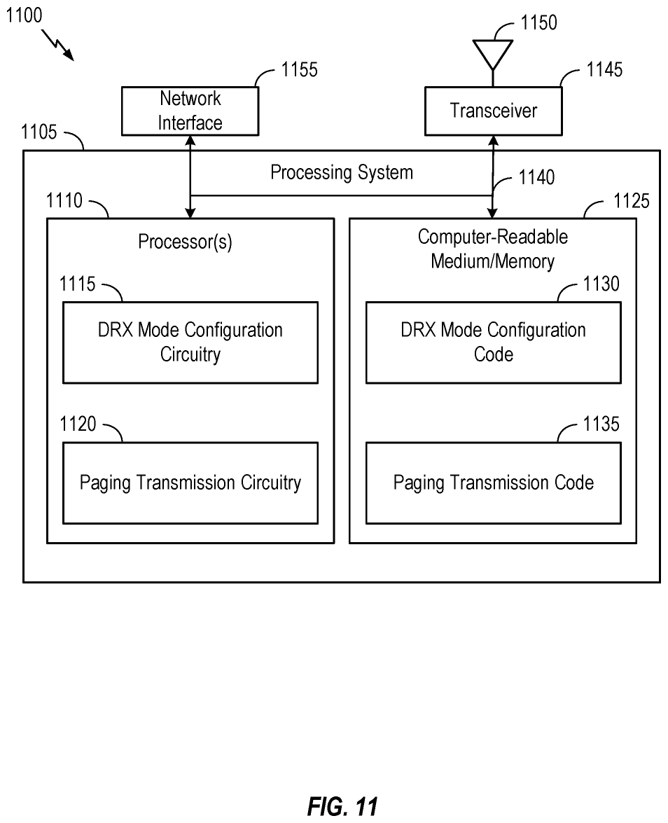

Method 900 begins at 905 with transmitting, to a UE, a first DRX mode configuration for a first RRC state, wherein the first DRX mode configuration specifies a periodic first PTW, and a second DRX mode configuration for a second RRC state, wherein the second DRX mode configuration specifies a periodic second PTW. In some cases, the operations of this step refer to, or may be performed by, DRX mode configuration circuitry as described with reference to FIG. 11.

Method 900 then proceeds to step 910 with transmitting different types of paging according to a schedule determined based on the first DRX mode configuration and the second DRX mode configuration. In some cases, the operations of this step refer to, or may be performed by, paging transmission circuitry as described with reference to FIG. 11.

In some aspects, the first DRX mode configuration and the second DRX mode configuration align start times of the first PTWs and the second PTWs. In some aspects, the first RRC state is an RRC inactive state; and the second RRC state is an RRC idle state.

In some aspects, the first DRX mode configuration also specifies a first DRX cycle length; an interval between a beginning of adjacent first PTWs corresponds to the first DRX cycle length; the second DRX mode configuration also specifies a second DRX cycle length; an interval between a beginning of adjacent second PTWs corresponds to the second DRX cycle length; and start times of at least some of the first PTWs align with start times of at least some of the second PTWs.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to the transceiver 1055 (e.g., a transmitter and/or a receiver). The transceiver 1055 is configured to transmit and receive signals for the communications device 1000 via the antenna 1060, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, cause the one or more processors 1010 to perform the method 800 described with respect to FIG. 8, or any aspect related to it. Note that reference to a processor performing a function of communications device 1000 may include one or more processors 1010 performing that function of communications device 1000.

In the depicted example, computer-readable medium/memory 1030 stores code (e.g., executable instructions), such as DRX mode processing code 1035, RRC state processing code 1040, and paging monitoring code 1045. Processing of the DRX mode processing code 1035, RRC state processing code 1040, and paging monitoring code 1045 may cause the communications device 1000 to perform the method 800 described with respect to FIG. 8, or any aspect related to it.

The one or more processors 1010 include circuitry configured to implement (e.g., execute) the code stored in the computer-readable medium/memory 1030, including circuitry such as DRX mode processing circuitry 1015, RRC state processing circuitry 1020, and paging monitoring circuitry 1025. Processing with DRX mode processing circuitry 1015, RRC state processing circuitry 1020, and paging monitoring circuitry 1025 may cause the communications device 1000 to perform the method 800 described with respect to FIG. 8, or any aspect related to it.

Various components of the communications device 1000 may provide means for performing the method 800 described with respect to FIG. 8, or any aspect related to it. For example, means for transmitting, sending or outputting for transmission may include transceivers 354 and/or antenna(s) 352 of the UE 104 illustrated in FIG. 3 and/or the transceiver 1055 and the antenna 1060 of the communications device 1000 in FIG. 10. Means for receiving or obtaining may include transceivers 354 and/or antenna(s) 352 of the UE 104 illustrated in FIG. 3 and/or the transceiver 1055 and the antenna 1060 of the communications device 1000 in FIG. 10.

According to some aspects, DRX mode processing circuitry 1015 receives, from a network entity, a first DRX mode configuration for a first RRC state, wherein the first DRX mode configuration specifies a periodic first PTW, and a second DRX mode configuration for a second RRC state, wherein the second DRX mode configuration specifies a periodic second PTW. According to some aspects, RRC state processing circuitry 1020 enters the first RRC state. According to some aspects, paging monitoring circuitry 1025 monitors for different types of paging, when the UE is in the first RRC state, according to a schedule determined based on the first DRX mode configuration and the second DRX mode configuration.

In some aspects, the first RRC state is an RRC inactive state; and the second RRC state is an RRC idle state. In some aspects, the first DRX mode configuration also specifies a first DRX cycle length; an interval between a beginning of adjacent first PTWs corresponds to the first DRX cycle length; the second DRX mode configuration also specifies a second DRX cycle length; an interval between a beginning of adjacent second PTWs corresponds to the second DRX cycle length; and start times of at least some of the first PTWs align with start times of at least some of the second PTWs. In some aspects, monitoring for different types of paging according to a schedule comprises: monitoring for one or more first types of paging during a first duration in which the first PTW and the second PTW overlap. In some aspects, the one or more first types of paging comprise: paging indicating SI updates, paging from a first network entity indicating downlink data for the UE, or paging from a second network entity indicating downlink data for the UE. In some aspects, the first network entity comprises a RAN entity and the second network entity comprises a CN network entity. In some aspects, the first duration occurs with a periodicity determined based on a minimum of: a default paging cycle, a cycle for paging from the first network entity, and a cycle for paging from the second network entity.

In some examples, paging monitoring circuitry 1025 determines that a duration of the second PTW is greater than a duration of the first PTW. In some examples, paging monitoring circuitry 1025 stops monitoring for paging after an end of the first PTW after making the determination. In some aspects, monitoring for different types of paging according to a schedule further comprises: determining that a duration of the second PTW is greater than a duration of the first PTW; and monitoring for one or more second types of paging during a second duration after making the determination, wherein the second duration corresponds to a portion of the second PTW that is non-overlapping with the first PTW. In some aspects, the one or more second types of paging comprise: paging from the second network entity indicating downlink data for the UE. In some aspects, the second duration occurs with a periodicity determined based on a UE-specific paging cycle, if configured for the UE; or a default paging cycle, if a UE-specific paging cycle is not configured for the UE.

In some aspects, monitoring for different types of paging according to a schedule further comprises: determining that a duration of the first PTW is greater than a duration of the second PTW; and monitoring for one or more third types of paging during a third duration after making the determination, if, wherein the third duration corresponds to a portion of the first PTW that is non-overlapping with the second PTW. In some aspects, the one or more third types of paging comprise: paging indicating SI updates and paging from the first network entity indicating downlink data for the UE. In some aspects, the third duration occurs with a periodicity determined based on a default paging cycle or a cycle for paging from the first network entity. In some aspects, the first DRX mode configuration also specifies a first DRX cycle length that is shorter than a second DRX cycle length specified by the second DRX mode configuration; and monitoring for different types of paging according to a schedule further comprises monitoring during first PTWs that are non-overlapping with second PTWs, for paging indicating SI updates and paging from the first network entity indicating downlink data for the UE. In some aspects, the UE monitors for paging indicating SI updates and for paging from the first network entity indicating downlink data for the UE during the first PTWs that are non-overlapping with second PTWs; and the first PTWs that are non-overlapping with second PTWs, during which the UE monitors for paging indicating SI updates and for paging from the first network entity indicating downlink data for the UE, occur with a periodicity determined based on a default paging cycle or a cycle for paging from the first network entity.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to the transceiver 1145 (e.g., a transmitter and/or a receiver) and/or a network interface 1155. The transceiver 1145 is configured to transmit and receive signals for the communications device 1100 via the antenna 1150, such as the various signals as described herein. The network interface 1155 is configured to obtain and send signals for the communications device 1100 via communication link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code) that when executed by the one or more processors 1110, cause the one or more processors 1110 to perform the method 900 described with respect to FIG. 9, or any aspect related to it. Note that reference to a processor of communications device 1100 performing a function may include one or more processors 1110 of communications device 1100 performing that function.

In the depicted example, the computer-readable medium/memory 1125 stores code (e.g., executable instructions), such as DRX mode configuration code 1130 and paging transmission code 1135. Processing of the DRX mode configuration code 1130 and paging transmission code 1135 may cause the communications device 1100 to perform the method 900 described with respect to FIG. 9, or any aspect related to it.

The one or more processors 1110 include circuitry configured to implement (e.g., execute) the code stored in the computer-readable medium/memory 1125, including circuitry such as DRX mode configuration circuitry 1115 and paging transmission circuitry 1120. Processing with DRX mode configuration circuitry 1115 and paging transmission circuitry 1120 may cause the communications device 1100 to perform the method 900 as described with respect to FIG. 9, or any aspect related to it.

Various components of the communications device 1100 may provide means for performing the method 900 as described with respect to FIG. 9, or any aspect related to it. Means for transmitting, sending or outputting for transmission may include transceivers 332 and/or antenna(s) 334 of the BS 102 illustrated in FIG. 3 and/or the transceiver 1145 and the antenna 1150 of the communications device 1100 in FIG. 11. Means for receiving or obtaining may include transceivers 332 and/or antenna(s) 334 of the BS 102 illustrated in FIG. 3 and/or the transceiver 1145 and the antenna 1150 of the communications device 1100 in FIG. 11.

According to some aspects, DRX mode configuration circuitry 1115 transmits, to a UE, a first DRX mode configuration for a first RRC state, wherein the first DRX mode configuration specifies a periodic first PTW, and a second DRX mode configuration for a second RRC state, wherein the second DRX mode configuration specifies a periodic second PTW. According to some aspects, paging transmission circuitry 1120 transmits different types of paging according to a schedule determined based on the first DRX mode configuration and the second DRX mode configuration.

In some aspects, the first DRX mode configuration and the second DRX mode configuration align start times of the first PTWs and the second PTWs. In some aspects, the first RRC state is an RRC inactive state; and the second RRC state is an RRC idle state. In some aspects, the first DRX mode configuration also specifies a first DRX cycle length; an interval between a beginning of adjacent first PTWs corresponds to the first DRX cycle length; the second DRX mode configuration also specifies a second DRX cycle length; an interval between a beginning of adjacent second PTWs corresponds to the second DRX cycle length; and start times of at least some of the first PTWs align with start times of at least some of the second PTWs.

### Example Clauses

Implementation examples are described in the following numbered clauses:
Clause 1: A method of wireless communication by a UE, comprising: receiving, from a network entity, a first DRX mode configuration for a first RRC state, wherein the first DRX mode configuration specifies a periodic first PTW, and a second DRX mode configuration for a second RRC state, wherein the second DRX mode configuration specifies a periodic second PTW; entering the first RRC state; and monitoring for different types of paging, when the UE is in the first RRC state, according to a schedule determined based on the first DRX mode configuration and the second DRX mode configuration.
Clause 2: The method of Clause 1, wherein: the first RRC state is an RRC inactive state; and the second RRC state is an RRC idle state.
Clause 3: The method of any one of Clauses 1 and 2, wherein: the first DRX mode configuration also specifies a first DRX cycle length; an interval between a beginning of adjacent first PTWs corresponds to the first DRX cycle length; the second DRX mode configuration also specifies a second DRX cycle length; an interval between a beginning of adjacent second PTWs corresponds to the second DRX cycle length; and start times of at least some of the first PTWs align with start times of at least some of the second PTWs.
Clause 4: The method of any one of Clauses 1-3, wherein monitoring for different types of paging according to a schedule comprises: monitoring for one or more first types of paging during a first duration in which the first PTW and the second PTW overlap.
Clause 5: The method of Clause 4, wherein the one or more first types of paging comprise: paging indicating SI updates, paging from a first network entity indicating downlink data for the UE, or paging from a second network entity indicating downlink data for the UE.
Clause 6: The method of Clause 5, wherein the first network entity comprises a RAN entity and the second network entity comprises a CN network entity.
Clause 7: The method of Clause 5, wherein the first duration occurs with a periodicity determined based on a minimum of: a default paging cycle, a cycle for paging from the first network entity, and a cycle for paging from the second network entity.
Clause 8: The method of Clause 5, further comprising: determining that a duration of the second PTW is greater than a duration of the first PTW; and stopping monitoring for paging after an end of the first PTW after making the determination.
Clause 9: The method of Clause 5, wherein monitoring for different types of paging according to a schedule further comprises: determining that a duration of the second PTW is greater than a duration of the first PTW; and monitoring for one or more second types of paging during a second duration after making the determination, wherein the second duration corresponds to a portion of the second PTW that is non-overlapping with the first PTW.
Clause 10: The method of Clause 9, wherein the one or more second types of paging comprise: paging from the second network entity indicating downlink data for the UE.
Clause 11: The method of Clause 9, wherein the second duration occurs with a periodicity determined based on: a UE-specific paging cycle, if configured for the UE; or a default paging cycle, if a UE-specific paging cycle is not configured for the UE.
Clause 12: The method of Clause 5, wherein monitoring for different types of paging according to a schedule further comprises: determining that a duration of the first PTW is greater than a duration of the second PTW; and monitoring for one or more third types of paging during a third duration after making the determination, if, wherein the third duration corresponds to a portion of the first PTW that is non-overlapping with the second PTW.
Clause 13: The method of Clause 12, wherein the one or more third types of paging comprise: paging indicating SI updates and paging from the first network entity indicating downlink data for the UE.
Clause 14: The method of Clause 13, wherein the third duration occurs with a periodicity determined based on a default paging cycle or a cycle for paging from the first network entity.
Clause 15: The method of Clause 5, wherein: the first DRX mode configuration also specifies a first DRX cycle length that is shorter than a second DRX cycle length specified by the second DRX mode configuration; and monitoring for different types of paging according to a schedule further comprises monitoring during first PTWs that are non-overlapping with second PTWs, for paging indicating SI updates and paging from the first network entity indicating downlink data for the UE.
Clause 16: The method of Clause 15, wherein: the UE monitors for paging indicating SI updates and for paging from the first network entity indicating downlink data for the UE during the first PTWs that are non-overlapping with second PTWs; and the first PTWs that are non-overlapping with second PTWs, during which the UE monitors for paging indicating SI updates and for paging from the first network entity indicating downlink data for the UE, occur with a periodicity determined based on a default paging cycle or a cycle for paging from the first network entity.
Clause 17: A method of wireless communication by a network entity, comprising: transmitting, to a UE, a first DRX mode configuration for a first RRC state, wherein the first DRX mode configuration specifies a periodic first PTW, and a second DRX mode configuration for a second RRC state, wherein the second DRX mode configuration specifies a periodic second PTW; and transmitting different types of paging according to a schedule determined based on the first DRX mode configuration and the second DRX mode configuration.
Clause 18: The method of Clause 17, wherein the first DRX mode configuration and the second DRX mode configuration align start times of the first PTWs and the second PTWs.
Clause 19: The method of any one of Clauses 17-18, wherein: the first RRC state is an RRC inactive state; and the second RRC state is an RRC idle state.
Clause 20: The method of any one of Clauses 17-19, wherein: the first DRX mode configuration also specifies a first DRX cycle length; an interval between a beginning of adjacent first PTWs corresponds to the first DRX cycle length; the second DRX mode configuration also specifies a second DRX cycle length; an interval between a beginning of adjacent second PTWs corresponds to the second DRX cycle length; and start times of at least some of the first PTWs align with start times of at least some of the second PTWs.
Clause 21: A processing system, comprising: a memory comprising computer-executable instructions; one or more processors configured to execute the computer-executable instructions and cause the processing system to perform a method in accordance with any one of Clauses 1-20.
Clause 22: A processing system, comprising means for performing a method in accordance with any one of Clauses 1-20.
Clause 23: A non-transitory computer-readable medium comprising computer-executable instructions that, when executed by one or more processors of a processing system, cause the processing system to perform a method in accordance with any one of Clauses 1-20.
Clause 24: A computer program product embodied on a computer-readable storage medium comprising code for performing a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a user equipment (UE), comprising:
receiving, from a network entity,
a first discontinuous reception (DRX) mode configuration for a first radio resource control (RRC) state, wherein the first DRX mode configuration specifies a periodic first paging time window (PTW), and
a second DRX mode configuration for a second RRC state, wherein the second DRX mode configuration specifies a periodic second PTW;
entering the first RRC state; and
monitoring for different types of paging, when the UE is in the first RRC state, according to a schedule determined based on the first DRX mode configuration and the second DRX mode configuration.

2. The method of claim 1, wherein:
the first RRC state is an RRC inactive state; and
the second RRC state is an RRC idle state.

3. The method of claim 1, wherein:
the first DRX mode configuration also specifies a first DRX cycle length;
an interval between a beginning of adjacent first PTWs corresponds to the first DRX cycle length;
the second DRX mode configuration also specifies a second DRX cycle length;
an interval between a beginning of adjacent second PTWs corresponds to the second DRX cycle length; and
start times of at least some of the first PTWs align with start times of at least some of the second PTWs.

4. The method of claim 1, wherein monitoring for different types of paging according to a schedule comprises:
monitoring for one or more first types of paging during a first duration in which the first PTW and the second PTW overlap.

5. The method of claim 4, wherein the one or more first types of paging comprise: paging indicating system information (SI) updates, paging from a first network entity indicating downlink data for the UE, or paging from a second network entity indicating downlink data for the UE.

6. The method of claim 5, wherein the first network entity comprises a radio access network (RAN) entity and the second network entity comprises a core network (CN) network entity.

7. The method of claim 5, wherein the first duration occurs with a periodicity determined based on a minimum of: a default paging cycle, a cycle for paging from the first network entity, and a cycle for paging from the second network entity.

8. The method of claim 5, further comprising:
determining that a duration of the second PTW is greater than a duration of the first PTW; and
stopping monitoring for paging after an end of the first PTW after making the determination.

9. The method of claim 5, wherein monitoring for different types of paging according to a schedule further comprises:
determining that a duration of the second PTW is greater than a duration of the first PTW; and
monitoring for one or more second types of paging during a second duration after making the determination, wherein the second duration corresponds to a portion of the second PTW that is non-overlapping with the first PTW.

10. The method of claim 9, wherein the one or more second types of paging comprise: paging from the second network entity indicating downlink data for the UE.

11. The method of claim 9, wherein the second duration occurs with a periodicity determined based on:
a UE-specific paging cycle, if configured for the UE; or
a default paging cycle, if a UE-specific paging cycle is not configured for the UE.

12. The method of claim 5, wherein monitoring for different types of paging according to a schedule further comprises:
determining that a duration of the first PTW is greater than a duration of the second PTW; and monitoring for one or more third types of paging during a third duration after making the determination, if, wherein the third duration corresponds to a portion of the first PTW that is non-overlapping with the second PTW.

13. The method of claim 12, wherein the one or more third types of paging comprise: paging indicating SI updates and paging from the first network entity indicating downlink data for the UE.

14. The method of claim 13, wherein the third duration occurs with a periodicity determined based on a default paging cycle or a cycle for paging from the first network entity.

15. The method of claim 5, wherein
the first DRX mode configuration also specifies a first DRX cycle length that is shorter than a second DRX cycle length specified by the second DRX mode configuration; and
monitoring for different types of paging according to a schedule further comprises monitoring during first PTWs that are non-overlapping with second PTWs, for paging indicating SI updates and paging from the first network entity indicating downlink data for the UE.

16. The method of claim 15, wherein:
the UE monitors for paging indicating SI updates and for paging from the first network entity indicating downlink data for the UE during the first PTWs that are non-overlapping with second PTWs; and
the first PTWs that are non-overlapping with second PTWs, during which the UE monitors for paging indicating SI updates and for paging from the first network entity indicating downlink data for the UE, occur with a periodicity determined based on a default paging cycle or a cycle for paging from the first network entity.

17. A method of wireless communication by a network entity, comprising:
transmitting, to a user equipment (UE),
a first discontinuous reception (DRX) mode configuration for a first radio resource control (RRC) state, wherein the first DRX mode configuration specifies a periodic first paging time window (PTW), and
a second DRX mode configuration for a second RRC state, wherein the second DRX mode configuration specifies a periodic second PTW; and
transmitting different types of paging according to a schedule determined based on the first DRX mode configuration and the second DRX mode configuration.

18. The method of claim 17, wherein first DRX mode configuration and second DRX mode configuration align start times of the first PTWs and the second PTWs.

19. The method of claim 17, wherein:
the first RRC state is an RRC inactive state; and
the second RRC state is an RRC idle state.

20. The method of claim 17, wherein:
the first DRX mode configuration also specifies a first DRX cycle length;
an interval between a beginning of adjacent first PTWs corresponds to the first DRX cycle length;
the second DRX mode configuration also specifies a second DRX cycle length;
an interval between a beginning of adjacent second PTWs corresponds to the second DRX cycle length; and
start times of at least some of the first PTWs align with start times of at least some of the second PTWs.

21. A user equipment (UE) configured for wireless communication, comprising: a memory comprising computer-executable instructions; and one or more processors configured to execute the computer-executable instructions and cause the UE to:
receive, from a network entity,
a first discontinuous reception (DRX) mode configuration for a first radio resource control (RRC) state, wherein the first DRX mode configuration specifies a periodic first paging time window (PTW), and
a second DRX mode configuration for a second RRC state, wherein the second DRX mode configuration specifies a periodic second PTW;
enter the first RRC state; and
monitor for different types of paging, when the UE is in the first RRC state, according to a schedule determined based on the first DRX mode configuration and the second DRX mode configuration.

22. A network entity configured for wireless communication, comprising: a memory comprising computer-executable instructions; and one or more processors configured to execute the computer-executable instructions and cause the network entity to:
transmit, to a user equipment (UE),
a first discontinuous reception (DRX) mode configuration for a first radio resource control (RRC) state, wherein the first DRX mode configuration specifies a periodic first paging time window (PTW), and
a second DRX mode configuration for a second RRC state, wherein the second DRX mode configuration specifies a periodic second PTW; and
transmit different types of paging according to a schedule determined based on the first DRX mode configuration and the second DRX mode configuration.
